(19) United States
(12) Patent Application Publication
(10) Pub. No.: US 2009/0128569 A1
(43) Pub. Date: May 21, 2009

(54) Image display program and image display apparatus

(76) Inventor: Takuya Yamazaki, Tokyo (JP)

Correspondence Address: JORDAN AND HAMBURG LLP, 122 EAST 42ND STREET, SUITE 4000, NEW YORK, NY, 10168, US

(21) Appl. No.: 12/287,417

(22) Filed: Oct. 8, 2008

(30) Foreign Application Priority Data
Oct. 9, 2007 (JP) 2007-263760

(51) Int. Cl. G06T 15/70

(52) U.S. Cl. 345/474

(57) ABSTRACT

An image display method for displaying an image of a character in a virtual space configures a computer to execute steps of, a parameter setting step for setting parameters concerning movement of the character, a reference unit time setting step for setting a reference unit time of stepwise change of the parameters, a minimal unit time setting step for setting a minimal unit time of a equally divided time of reference unit time, a basic setting step of parameters, for setting the parameters for each reference unit time, and for allocating the parameters for each minimal unit time, a smoothing step for setting a smoothed parameters for each said minimal unit time, the parameters being allocated to the minimal unit time, and a display step for displaying the object according to said parameters set in the smoothing step for each minimal unit time.

### BACKGROUND OF THE INVENTION

1. Field of the Invention

The present invention relates to an image display Program and an image display apparatus for displaying an image of objects existing within a virtual space.

2. Prior Art

When movement is to be expressed of an object such as a character on a game machine etc., calculation of fine movement of each portions of the object is unpractical because the data volume to be processed and the calculation load are immense.

The Japanese Patent Publication of Unexamined Application 2001-160150 discloses a “Motion Display Method of a Game Character” in which interpolation frames are prepared beforehand for interpolating motions between motions A and B of different reference posture when the motion of the object is changed from the motion A to the motion B. The interpolation frames are generated by Affine transformation of polygons of the object. Then, number n of interpolation frames is set according to correlation between the motions A and B. And n frames from the first frames of the motion B are substituted by the interpolating frames. A lot of calculation load is needed.

The Japanese Patent Gazette No. 3618298 discloses a “Motion Display Method” in which frames of motions A and B are composed when the motion A is transferred to the motion B. The composing ratio of the motion A is high first and the composing ration of the motion B is gradually increased so as to interpolating composed motion is generated. A smooth interpolation is realized. However, the displayed image is not always natural.

### BRIEF SUMMARY OF THE INVENTION

The present invention is invented so as to solve the conventional problems above and has an object to realize clear and natural motion display.

The present invention is an image display program for displaying an image of a character in a virtual space, said program letting a computer execute steps of, a parameter setting step for setting parameters concerning movement of said character, a reference unit time setting step for setting reference unit time of stepwise change of the parameters, a minimal unit time setting step for setting a minimal unit time of a equally divided time of said reference unit time, a parameter allocating step for allocating said parameters to each reference unit time, and for allocating said parameters to each said minimal unit time, a smoothing step for setting a smoothed parameters for each said minimal unit time, said parameters being allocated to said minimal unit time, and a display step for displaying said object according to said parameters set in said smoothing step for each minimal unit time.

Therefore, a clear and natural movement can easily realized. A clear and natural rotational movement is displayed by a hardware of rather small size.

The present invention is an image display apparatus for displaying an image of a character in a virtual space comprising a parameter setting means for setting parameters concerning movement of said character, a reference unit time setting means for setting a reference unit time of stepwise change of the parameters, a minimal unit time setting means for setting a minimal unit time of a time equally divided said reference unit time, a parameter allocating means for allocating said parameters to each reference unit time, and for allocating said parameters to each said minimal unit time, a smoothing means for setting a smoothed parameters for each said minimal unit time, said parameters being allocated to said minimal unit time, and a display means for displaying said object according to said parameters set by said smoothing means for each minimal unit time.

Therefore, a clear and natural movement can easily realized. A clear and natural rotational movement is displayed by a hardware of rather small size.

In the image display program and image display apparatus, the parameters includes, for example, a rotational angular velocity (ωx, ωy, ωz) around three dimensional coordinate axes (X-, Y- and Z-coordinate) in said virtual space, said rotational angular velocity ωx being rightward rotation around said X-axis viewing toward plus direction of said X-axis, said rotational angular velocity ωy being rightward rotation around said Y-axis viewing toward plus direction of said Y-axis, and said rotational angular velocity ωy being rightward rotation around said Z-axis viewing toward plus direction of said Z-axis.

Therefore, any three dimensional rotational movement may be clearly and naturally expressed.

In the image display program and image display apparatus, said parameters includes a posture parameter indicative of posture of said character.

Therefore, any three dimensional rotational movement may be clearly and naturally expressed.

In the image display program and image display apparatus, said reference unit time is for example 0.5 sec. Said smoothing step and smoothing means sets a smoothed parameters of said successive minimal unit time. Said smoothing is executed for example by a weighted addition of a plurality of successive parameters. Weights of said weighted addition may be equal to one another. Said minimal unit time is for example a quarter of said reference unit time.

Therefore, movement is displayed utmost clearly and naturally according to experiences.

### BRIEF DESCRIPTION OF THE DRAWINGS

FIG. 1 is an elevation view showing an embodiment of a game machine (image processing apparatus) according to the present invention.

FIG. 2 is a block diagram showing the apparatus of FIG. 1.

FIG. 3 is a figure showing a virtual space displayed on the game machine in FIG. 1.

FIG. 4 is an elevation view showing a situation of a character object of FIG. 3 standing upright, which moves in the virtual space.

FIG. 5 is a right side view of FIG. 4.

FIG. 6 is an elevation view showing a situation of the object of FIG. 4 raising one hand.

FIG. 7 is a right side view of FIG. 6.

FIG. 8 is a left side view of FIG. 6.

FIG. 9 is an elevation view showing a situation of the object of FIG. 4 holding by arms knees drawn up,

FIG. 10 is a right side view of FIG. 9,

FIG. 11 is a table showing posture parameters and change in rotational angular velocity of the character for each reference unit time,

FIG. 12 is a table showing posture parameters and change in rotational angular velocity of the character for each maximal unit time,

FIG. 13 is a table showing a smoothed result of posture parameters and change in rotational angular velocity in FIG. 12,

FIG. 14 is a table showing a rotational angle in FIG. 13 for each maximal unit time,

FIG. 15 is a table showing a total rotational angle obtained by an integration of the rotational angle in FIG. 14,

FIG. 16 is a graph showing the posture parameters in FIG. 13 and the total rotational angle in FIG. 15,

FIG. 17 is a perspective view showing the character of FIG. 4 simplified for explaining composition of posture and rotation of the character,

FIG. 18 is a perspective view showing the character of FIG. 9 simplified for explaining composition of posture and rotation of the character,

FIG. 19 is a perspective view showing a situation of the character in FIGS. 17 and 18 with composed posture and rotation,

FIG. 20 is a perspective view showing another situation of the character in FIGS. 17 and 18 with composed posture and rotation,

FIG. 21 is a perspective view showing further another situation of the character in FIGS. 17 and 18 with composed posture and rotation,

FIG. 22 is a figure showing a skeleton of the character in FIG. 4 for the posture composition,

FIG. 23 is a figure showing a skeleton of the character in FIG. 5 for the posture composition,

FIG. 24 is a figure showing a skeleton of the character in FIG. 6 for the posture composition,

FIG. 25 is a figure showing a skeleton of the character in FIG. 7 for the posture composition,

FIG. 26 is a figure showing a skeleton of the character in FIG. 8 for the posture composition,

FIG. 27 is a figure showing a skeleton of the character in FIG. 9 for the posture composition,

FIG. 28 is a flowchart showing a processing of the first embodiment of an image processing program according to the present invention,

FIG. 29 is a table showing posture parameters composed by smoothing.

FIG. 30 is a graph showing posture parameters composed by smoothing, and

FIG. 31 is a flowchart showing a processing of the second embodiment of an image processing program according to the present invention.

### DETAILED DESCRIPTION OF THE INVENTION

Preferred embodiments are described of an image display program and an image display apparatus according to the present invention, hereafter.

### First Embodiment

### [Image Display Apparatus]

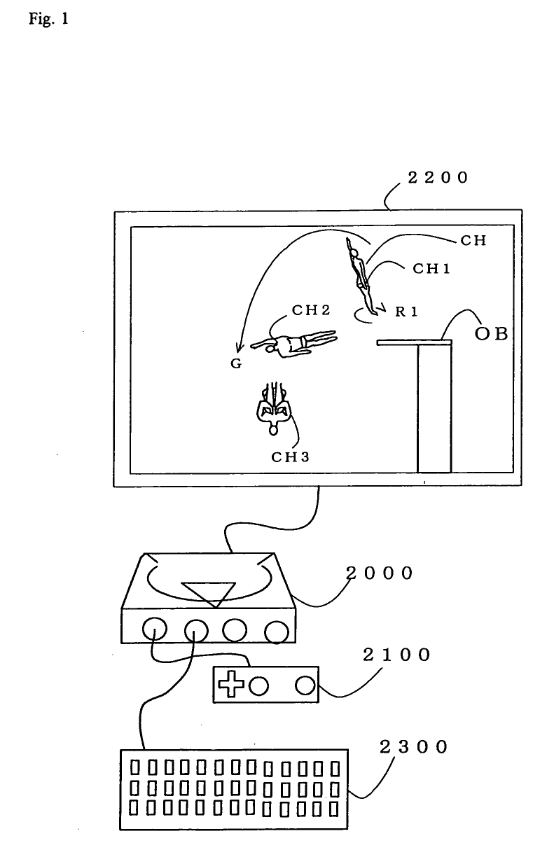

In FIG. 1, a game machine (image display apparatus) 2000 includes a controller 2100, a display apparatus 2200 such as a TV monitor and a keyboard 2300.

On the display apparatus 2200, an image of character objects CH (shown by CH1 to CH3) moving in a virtual space. The characters CH1 to CH3 perform diving from an object OB of diving platform.

For example, the character CH jumps backward from the diving platform OB with left hand raised and rotating rightward (shown by an arrow R1). The character drops along a parabolic orbit G as shown by an image CH2. Then, the character changes its posture to a posture of holding knees (shown by CH3) and drops further. According to this embodiment, these movements can be clearly and naturally expressed by a hardware of rather low performance.

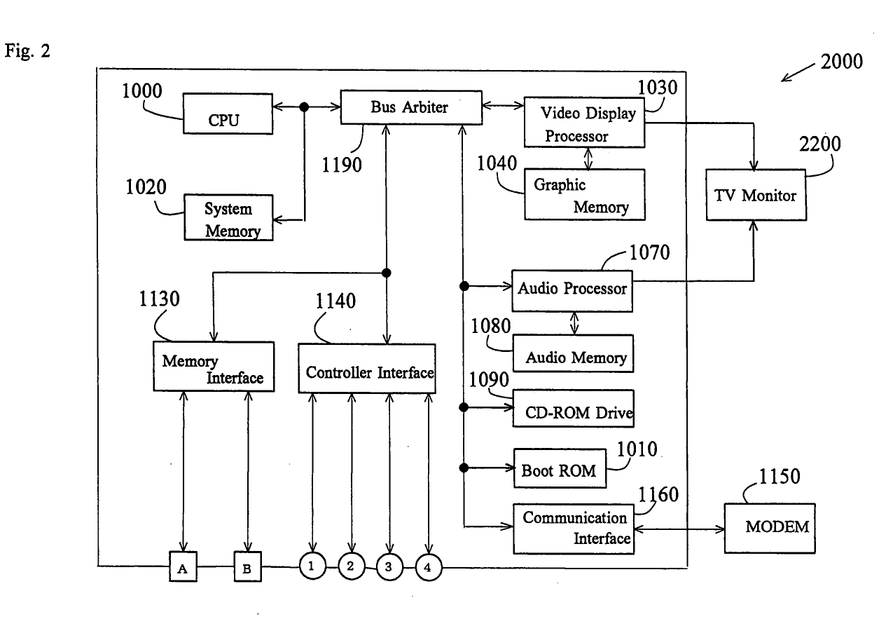

The above movement display of the character CH is executed by an input signal from the controller 2100 or by cooperation of a CPU 1000, a system memory 1020, a video processor and a graphic memory 1040, according to a predetermined program. The CPU 1000, system memory 1020, video processor and graphic memory 1040 are described later with reference to FIG. 2.

However, there are other various objects in the virtual space, only the character CH is described, here, for easy understanding of the present invention.

In FIG. 2, the game machine (image display apparatus) 2000 includes the CPU 1000 for controlling the total component of the game machine, a boot ROM 1010 for storing a program which starts the game machine up, and the system memory 1020 for storing a program executed by the CPU 1000 and data.

The game machine 2000 is provided with a video processor 1030 for generating and controlling images to be displayed, and a graphic memory 1040 for storing material images for the generated images and for storing the generated images. The video processor 1030 displays the generated images on the display apparatus 2200.

The game machine 2000 is provided with an audio processor 1070 for generating sound and an audio memory 1080 for storing sound data. The audio processor 1070 generates digital signal of sound according to the data stored in the audio memory 1080 and outputs the sound from a speaker or headphone (not shown).

The game machine 2000 is provided with a CD-ROM drive 1090 etc. of a memory device for program data and others. In the memory device, a game program, data etc. are read into the system memory 1020, graphic memory 1040 or audio memory 1080.

The game machine is provided with a memory interface 1130 by which players can read and write their own memory cards A and B. The players can register result of a game, situation of an interrupted game etc.

The game machine 2000 is provided with a modem 1150 connected through a communication interface 1160. A network game can be executed by a plurality of game machines 2000 through a network. A statistics of the game result, a ranking of the players, various events and other various information concerning games can be obtained from a server (not shown).

The game machine 2000 is provided with a controller interface 1140 having terminals 1 to 4 to which a controller 2100 is connected.

### [Image Display Algorithm]

Next, an image display algorithm executed by the game machine 2000 is described.

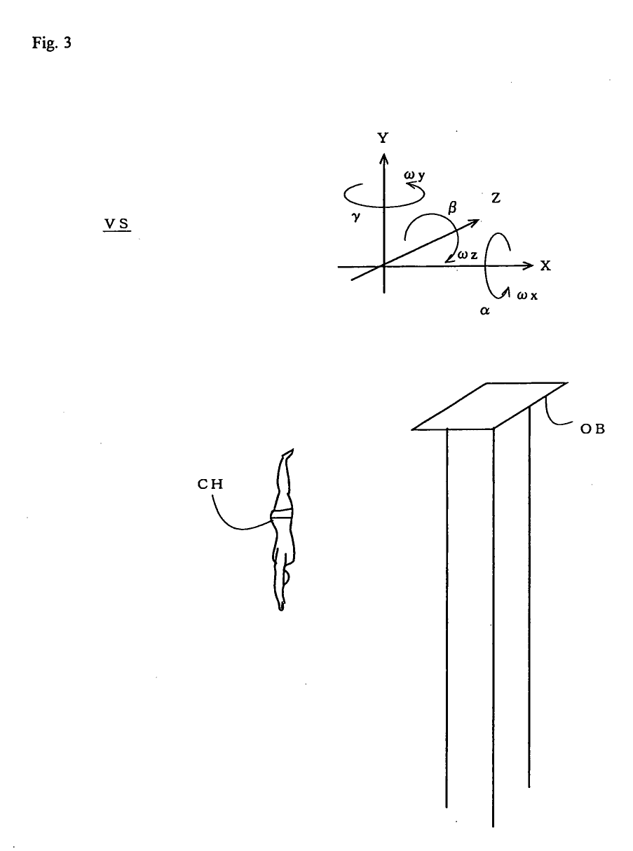

In FIG. 3, three dimensional coordinates of X, Y and Z-coordinates is defined in a virtual space VS. For example, a rightward rotational angle a around the X-axis, a rightward rotational angle β around the Y-axis and a rightward rotational angle γ around the Z-axis, and rotational angular velocities ωx, ωy and ωz of the rotational angles a, β and γ are defined.

The character CH and other objects are arranged in the virtual space VS at any positions, in any postures and with any rotational anguler velocity by setting these parameters, that is, the coordinates (X, Y, Z), rotational angles (a, β, γ) and rotational anguler velocity (ωx, ωy, ωz).

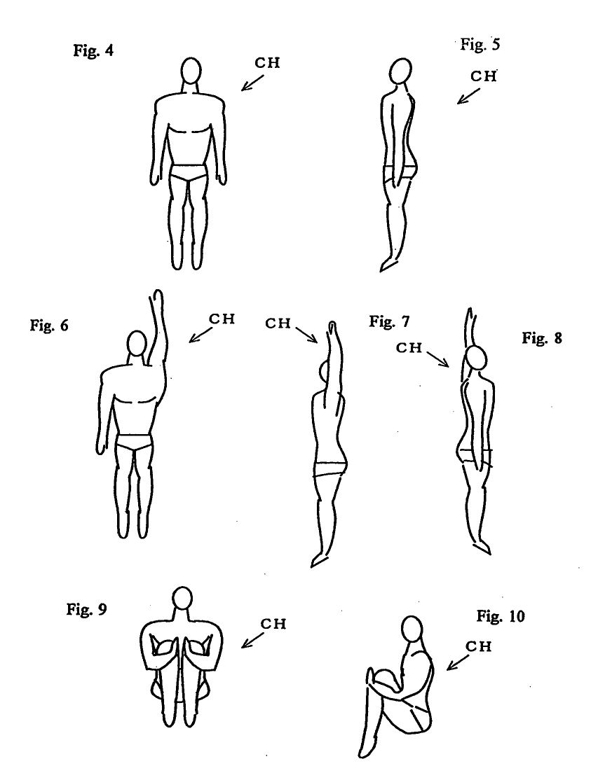

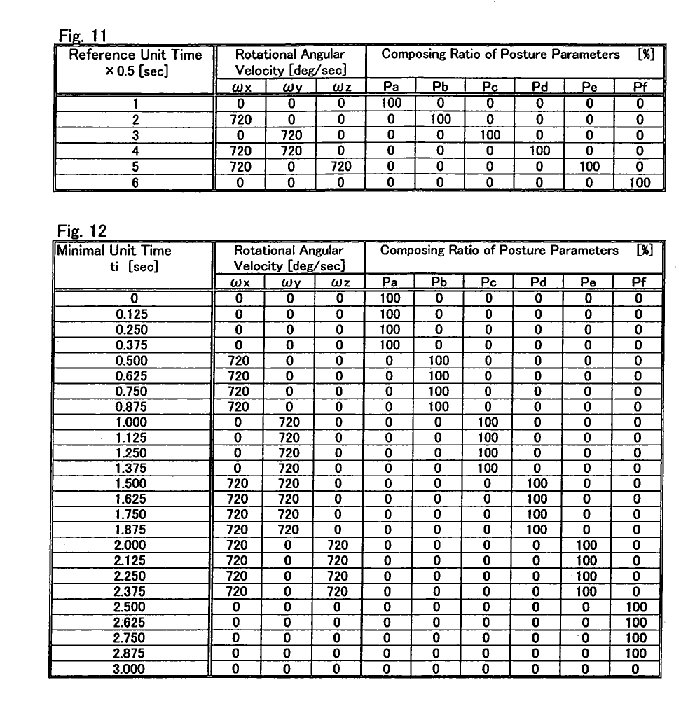

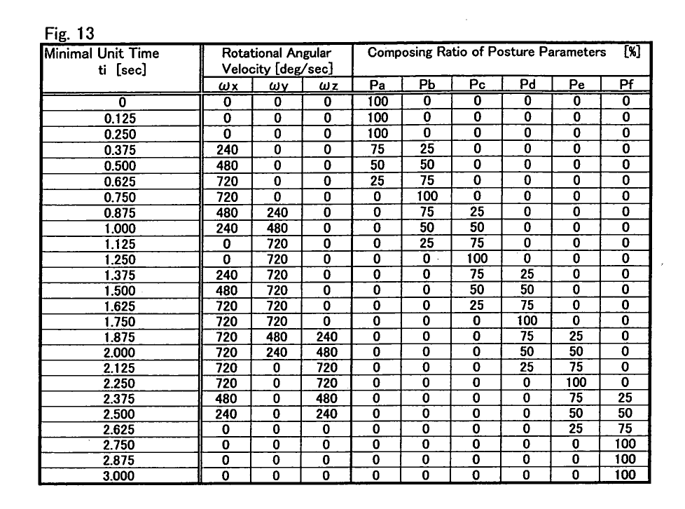

As shown in FIGS. 4 to 10, a plurality of postures, for example, of standing upright (FIGS. 4 and 5), with raising hand (FIGS. 6 to 8) and with knees drawn up and held by arms (FIGS. 9 and 10) are defined for the character CH. Any of the postures can be selected and be continuously changed.

In order to rotate the character CH with changing the posture, the posture and the rotational angular velocity are set for each reference unit time (0.5 sec, for example), as shown in FIG. 11, for example.

### [Parameter, Reference Unit Time and Minimal Unit Time]

In FIG. 11, the rotational angular velocity (ωx, ωy, ωz) changes (0, 0, 0)[deg], (720, 0, 0)[deg], (0, 720, 0)[deg], (720, 720, 0)[deg], (720, 0, 720)[deg] and (0, 0, 0)[deg]. In FIG. 11, six postures are set. The posture is expressed by posture parameter (described later) Pa, Pb, Pc, Pd, Pe and Pf, and changes from Pa to Pb, then to Pc, then to Pd, then to Pe, and then to Pf.

In order to clarify the dynamic change of the rotation and the posture, the reference unit time (T, hereafter) is divided into minimal unit times (t, hereafter), the rotational angular velocity (ωx, ωy, ωz) and the posture parameter (Pa, Pb, Pc, Pd, Pe, Pf) are allocated to each minimal unit time.

In FIG. 12, the reference unit time T=1 is divided into minimal unit times of 0≦t<0.125 [sec], 0.125≦t<0.250 [sec], 0.250≦t<0.375 [sec] and 0.375≦t<0.500 [sec].

The reference unit time T=2 is divided into minimal unit times of 0.500≦t<0.625 [sec], 0.625≦t<0.750 [sec], 0.750≦t<0.875 [sec] and 0.875≦t<1.000 [sec].

The reference unit time T=3 is divided into minimal unit times of 1.000≦t<1.125 [sec], 1.125≦t<1.250 [sec], 1.250≦t<1.375 [sec] and 1.375≦t<1.500 [sec].

The reference unit time T=4 is divided into minimal unit times of 1.500≦t<1.625 [sec], 1.625≦t<1.750 [sec], 1.750≦t<1.875 [sec] and 1.875≦t<2.000 [sec].

The reference unit time T=5 is divided into minimal unit times of 2.000≦t<2.125 [sec], 2.125≦t<2.250 [sec], 2.250≦t<2.375 [sec] and 2.375≦t<2.500 [sec].

The reference unit time T=6 is divided into minimal unit times of 2.500≦t<2.625 [sec], 2.625≦t<2.750 [sec], 2.750≦t<2.875 [sec] and 2.875≦t<3.000 [sec].

### [Posture Parameter]

The posture parameter is described concerning the characters CH shown in FIGS. 4 to 10.

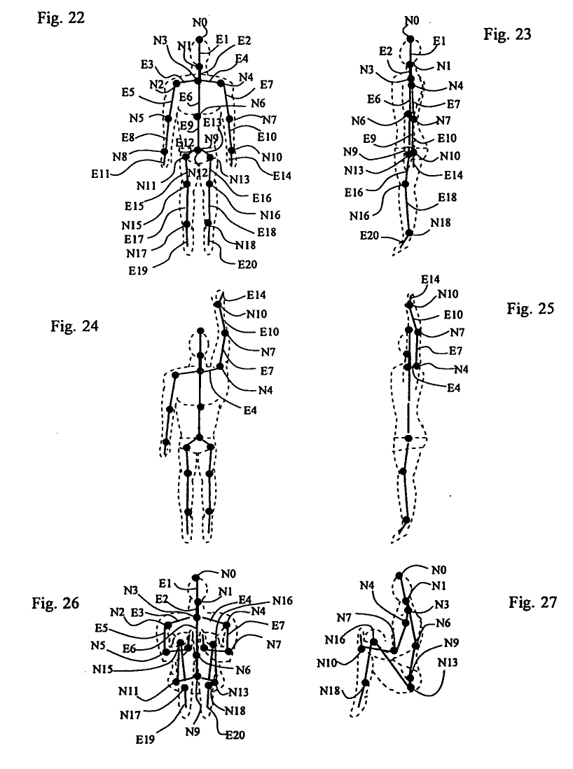

The character CH is modeled to be a construction (called “skeleton”) consisting of moving components of links (called “arc”). The posture is defined by relative angles at conjunction points (called “node”) of arcs. As shown in FIG. 22 corresponding to FIG. 4, the character CH consists of, for example, a skeleton of a plurality of arcs E1 to E20 covered with a head, a torso, arms, feet etc. An end N0 (node at parietal point) of the uppermost arc E1 is defined as a reference point.

FIGS. 22 to 27 shows skeletons corresponding to the character of FIGS. 4 to 9, for the posture composition.

In order to clarify the expression, references are shown in FIGS. 24 and 25 for different portions relative to FIGS. 22 and 23, and references for arcs are omitted in FIGS. 24 and 25.

The arc E1 is rotatably connected with the arc E2 (at the neck) by a node N1. The arc E2 is rotatably connected with the arc E3, E4 (at the shoulder) and E6 (at the chest) by a node N3.

The arc E3 is rotatably connected with the arc E5 (at the upper right hand) by a node N2. The arc E5 is rotatably connected with the arc E8 (at the right forearm) by a node N5. The arc E8 is rotatably connected with the arc E11 (at the right hand) by a node N8.

The arc E4 is rotatably connected with the arc E7 (at the upper left hand) by a node N4. The arc E7 is rotatably connected with the arc E10 (at the left forearm) by a node N7. The arc E10 is rotatably connected with the arc E14 (at the left hand) by a node N10.

The arc E6 is rotatably connected with the arc E9 (at the belly) by a node N6. The arc E9 is rotatably connected with the arc E12 and E13 (at the pelvis) by a node N9.

The arc E12 is rotatably connected with the arc E15 (at the right femul) by a node N11. The arc E15 is rotatably connected with the arc E17 (at the right leg) by a node N15. The arc E17 is rotatably connected with the arc E19 (at the right foot) by a node N17.

The arc E13 is rotatably connected with the arc E16 (at the left femul) by a node N13. The arc E16 is rotatably connected with the arc E18 (at the left leg) by a node N18. The arc E18 is rotatably connected with the arc E20 (at the left foot) by a node N20.

The skeleton is settled in position and angle when the coordinate (X, Y, Z) of the node N0 and the rotational angle (α, β, γ) are decided. The other arcs E2 to E20 are settled in angles when the relative angles at the nodes N1 to N18. A group of parameters for settling the nodes and arcs is called “posture parameter”.

### [Rotation and Composition of Postures]

Next, it is described how the rotation and composition of postures are executed. Here, in order to simplify the description, the character is modeled to be a more simple model.

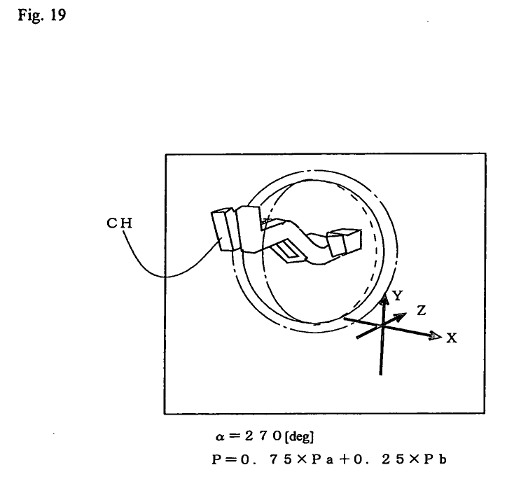

The character CH In FIG. 19 is rotated around the X-axis by a=270 [deg] with respect to the upright standing posture (posture parameter Pa) of FIG. 17 and the unrotated posture with holding knees (posture parameter Pb) in FIG. 18. The posture parameter P of the character in FIG. 19 is a composite posture parameter of 75 [%] of Pa and 25 [%] of Pb. The composite posture parameter P is calculated by addition of 75 [%] parameters included in Pa and 25 [%] parameters included in Pb corresponding to those of Pa.

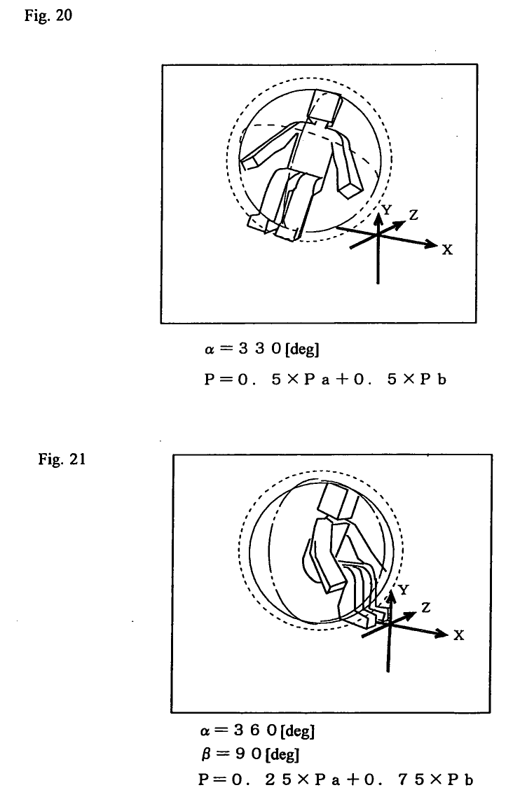

In FIG. 20, the character CH is of the posture parameter P as a composite posture parameter with 50 [%] of Pa ad 50 [%] Pb. The composite posture parameter P is calculated by addition of 50 [%] parameters included in Pa and 50 [%] parameters included in Pb corresponding to those of Pa.

In FIG. 21, the character CH is rotated around the X-axis by a=360 [deg] and around the Y-axis by β=90 [deg], and its posture parameter P is a composite posture parameter with 25 [%] of Pa and 75 [%] Pb. The composite posture parameter P is calculated by addition of 25 [%] parameters included in Pa and 75 [%] parameters included in Pb corresponding to those of Pa.

### [Rotation]

In the rotational angle (ωx, ωy, ωz) allocated to each minimal unit time is applied to the rotation of the character, the rotation is abrupt and unnatural at the beginning and at the end. And the rotation is unnatural at the time when the rotational angular velocity is changed.

Therefore, in this embodiment, the rotational angular velocity (ωx, ωy, ωz) is smoothed for a time distance of three minimal unit times, for example, according to formulae (1) to (3).

ωx(ti)={ωx(ti−1)+ωx(ti)+ωx(ti+1)}/3 formula (1)

ωy(ti)={ωy(ti−1)+ωy(ti)+ωy(ti+1)}/3 formula (2)

ωz(ti)={ωz(ti−1)+ωz(ti)+ωz(ti+1)}/3 formula (3)
ti−1: (i−1)th minimal unit time
ti: ith minimal unit time
ti+1: (i+1)th minimal unit time
ωx: ωx at ith minimal unit time
ωy: ωy at ith minimal unit time
ωz: ωz at ith minimal unit time

As an exception, in the case there is not ti−1 at the time ti=0 in FIG. 12, ωx(ti−1), ωy(ti−1), ωz(ti−1) are omitted. In the case there is not ti+1 at the time ti=3.000, ωx(ti+1), ωy(ti+1), ωz(ti+1) are omitted.

The smoothing may be executed for shorter or longer time distance. However, the smoothing in the formula (4) is a weighted addition with equal weights, the smoothing may be executed by a weighted addition with different weights for successive parameters.

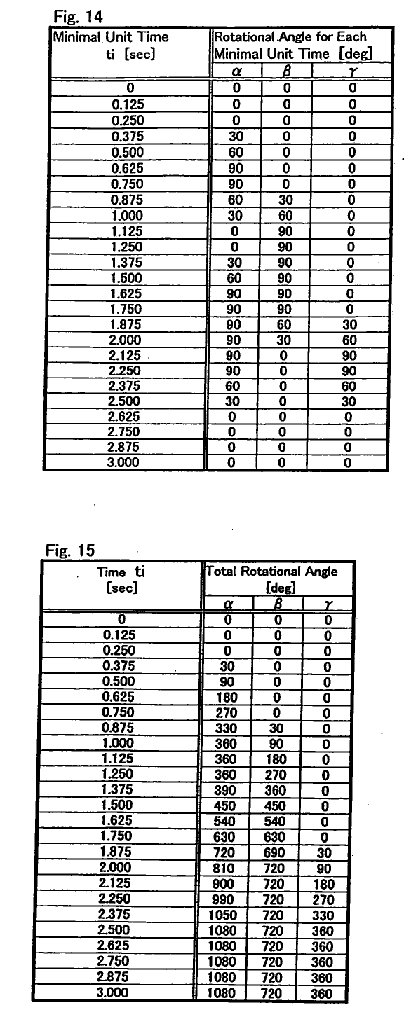

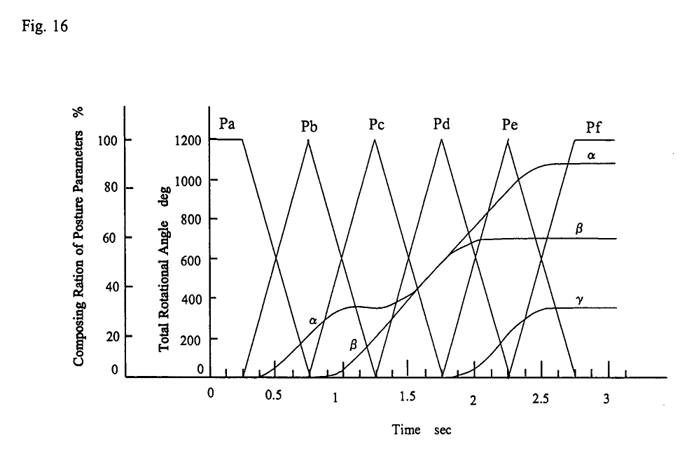

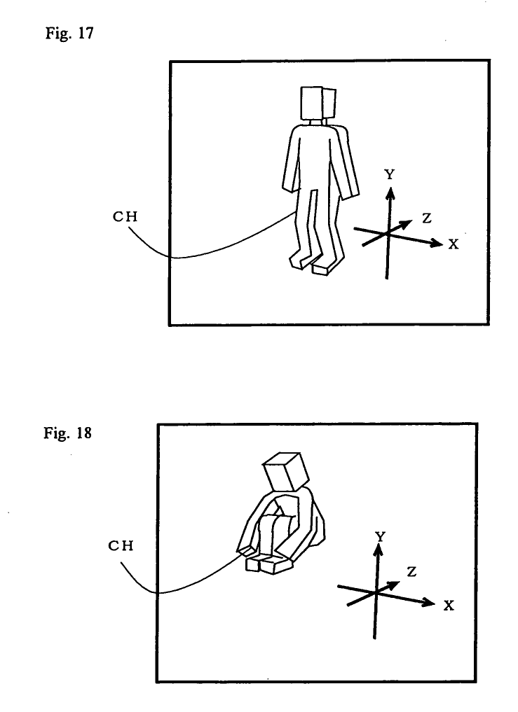

The smoothing execution result is shown in FIG. 13. The rotational angular velocity (a, β, γ) for reach minimal unit time is shown in the table of FIG. 13. A total rotational angle as an integration of the rotational angle in FIG. 14 is shown in the table of FIG. 15. The posture parameter in FIG. 13 and the total rotational angle in FIG. 15 are shown in a graph of FIG. 16.

It will be apparent from FIG. 16, the rotational angle (a, β, γ) clearly changes from a macro point of view but the fine angular change is soothed from micro point of view. Therefore, the angular change is extremely clear and natural as a whole.

According to experiences, a very good result is obtained by the reference unit time of T=0.5 sec and D=4. The calculation condition may be improved by a combination of various reference unit time T and various number D of division.

### [Dynamic Change of Posture]

As for the posture parameter, the change of the posture parameter Pa→Pb→Pc→Pd→Pe→Pf in FIG. 12 is realized by setting each posture parameter 100 [%] and other posture parameters 0 [%]. However, if these setting is applied to the dynamic posture change of the character CH, abrupt and unnatural posture change occurs.

Therefore, in this embodiment, similarly to the posture parameter of the patent document 2, at the transition time from a posture to the other posture, both postures are composed according to formula (4) so that the posture change becomes moderate. According to the formula (4), the posture parameter composition is executed with setting the transition time to be 2×Tr times of the minimal unit time and the minimal unit time after Pa to be ith minimal unit time.

P(ti−Tr+1)={Pa×(1−R)+Pb×R}

P(ti−Tr+2)={Pa×(1−R×2)+Pb×(R×2)}

. . .

P(ti)={Pa×0.5+Pb×0.5}

P(ti+1)={Pa×0.5+Pb×0.5}

. . .

P(ti+Tr−1)={Pa×R+Pb×(1−R)} formula (4)

Here,

R=1/(2×Tr)

P(ti): composed posture parameter of ith minimal unit time

In FIG. 13 shows a calculation result of the composite posture parameter P in the transition time in FIG. 12, with D=4 and Tr=2. FIG. 16 shows a graph of the calculation result.

In FIG. 16, curves with reference Pa, Pb, Pc, Pd, Pe and Pf are composite posture parameters. Each posture parameter reach 100 [%] of Pa, Pb, Pc, Pd, Pe or Pf at the point Pa, Pb, Pc, Pd, Pe and Pf is attached. In the transition time, the change of Pa→Pb→Pc→Pd→Pe→Pf is moderate.

In the game machine of FIGS. 1 and 2, the CPU 1000 and the system memory 1020 cooperatively function as a parameter setting means for setting the parameters concerning the movement of the character CH, such as, the coordinate (X, Y, Z), rotational angle (a, β, γ), rotational angular velocity (ωx, ωy, ωz), posture parameters Pa to Pf etc. The CPU 1000 and the system memory 1020 cooperatively function as a reference unit time setting means for setting a reference unit time T, as a minimal unit time setting means for setting the minimal unit time t and as a parameter allocating means for allocating the parameters to each minimal unit time.

Further, the CPU 1000 and the system memory 1020 cooperatively function as a smoothing means for smoothing the rotational angular velocity (ωx, ωy, ωz) of a plurality of successive unit times, which is set by the parameter allocating means to each minimal unit time. The rotational angular velocity of each minimal unit time is substituted by the smoothed rotational angular velocity.

Further, the CPU 1000, the system memory 1020, the video display processor 1030 and the graphic memory 1040 cooperatively function as a display means for displaying the object CH according to the smoothed rotational angular velocity of each minimal unit time set by the smoothing means.

### [Image Display Program]

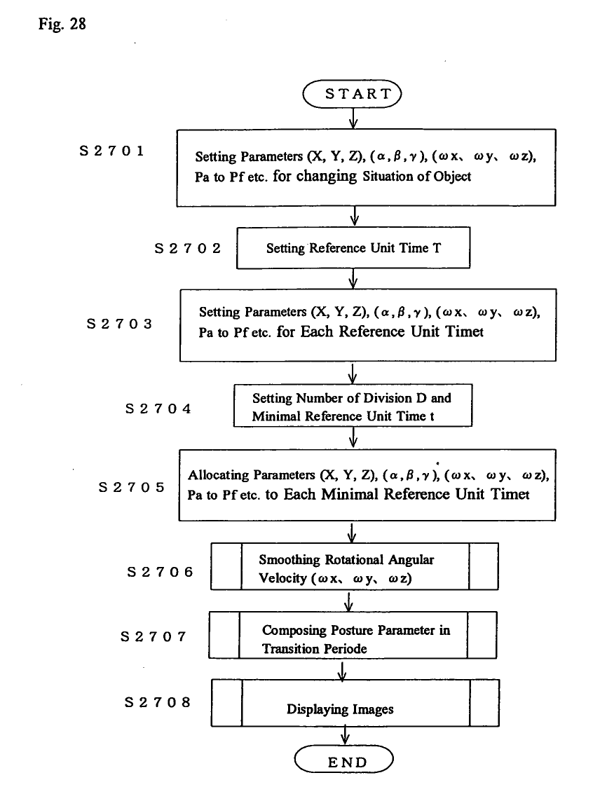

An image display program for executing the above image display algorithm on the image processing apparatus of FIG. 1 is shown in FIG. 28. The image display program includes following steps.

Step S2701: First, necessary parameters for changing the object CH to be displayed is set. In this embodiment, parameters are coordinate (X, Y, Z), rotational angle (a, β, γ), rotational angular velocity (ωx, ωy, ωz), posture parameters Pa to Pf and so forth.

Step S2702: Following to the step S2701, the reference unit time T is set.

Step S2703: Following to the step S2702, the coordinate (X, Y, Z), rotational angle (a, β, γ), rotational angular velocity (ωx, ωy, ωz), posture parameters Pa to Pf and so forth are allocated to each reference unit time T.

Step S2704: Following to the step S2703, the number of division D and the minimal unit time t are set.

Step S2705: Following to the step S2703, the parameters allocated to each reference unit time T are allocated to each minimal unit time t.

Step S2706: According to the formulae (1) to (3), the rotational angular velocity (ωx, ωy, ωz) is smoothed.

Step S2707: According to the formula (4), the posture parameters are composed in the transition time.

The image of the object is displayed for each minimal unit time. Then, the processing is terminated.

According to the above image display program, the rotational angle changes clearly and naturally as a whole because the change is clear from the macro point of view and the angular change is smoothed from micro point of view. And the dynamic posture change is natural.

Since the calculation of step S2706, that is, the calculation of formulae (1) to (3), is extremely simple, the calculation load is light and can be processed by a hardware of rather low performance.

Further, the calculation of the steps S2704 to S2706 may be recursively executed. So, when the division of the reference unit time by D at the first processing, the calculation by division of n-th power of D is easily executed for smaller minimal unit time.

Further, the calculation of the steps S2704 to S2706 may be always applied as a parameter output routine because they output constant parameters as far as the parameters are not changed. The software construction is simple.

### Second Embodiment

Next, the second embodiment of an image display apparatus and image display program according to the present invention.

In the second embodiment, in addition to the processing of the first embodiment, the posture parameters are independently smoothed from one another.

### [Image Display Algorithm]

As shown in FIG. 12, generally, each posture parameter changes so that a posture is changed one after another. Each posture parameter changes from 0% to 100% and returns to 0%. Therefore, by smoothing each posture parameter independently from the others, posture change during the transition time between 0% and 100% is smoothed and abrupt change is prevented.

For example, formula (5) is applied to the smoothing of the posture parameter Pa for three minimal unit time.

Pa(ti)={Pa(ti−1)+Pa(ti)+Pa(ti+1)}/3 formula (5)

Here,

Pa: Pa at the ith minimal unit time

As an exception, in the case there is not ti−1 at the time ti=0 in FIG. 12, Pa(ti−1) is omitted. In the case there is not ti+1 at the time ti=3.000, Pa(ti+1) is omitted.

The smoothing may be executed for shorter or longer time distance.

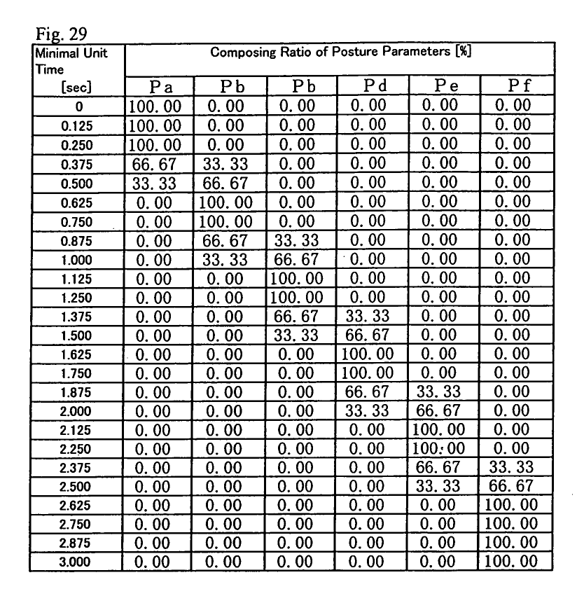

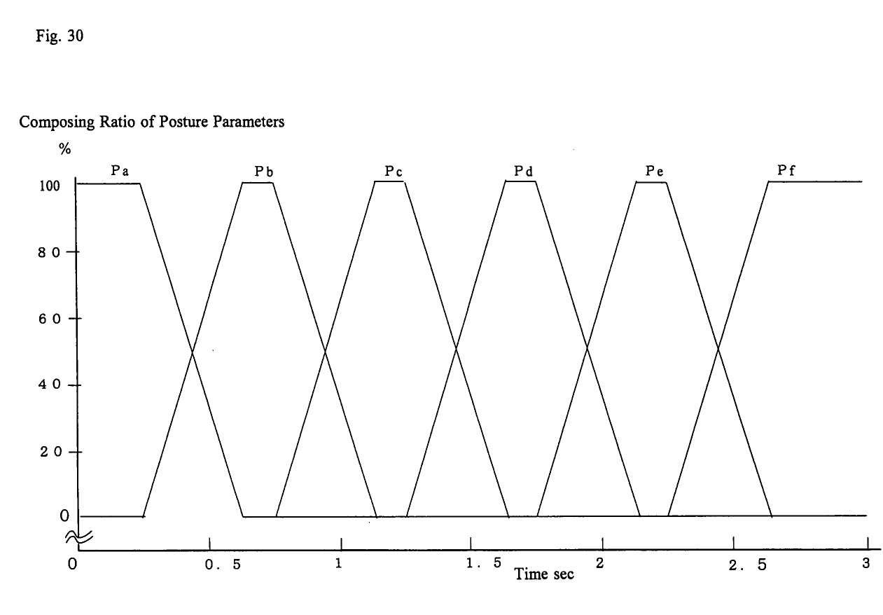

FIG. 29 shows a table of posture parameters Pa to Pf of FIG. 12 independently smoothed from the others, and FIG. 30 is a graph corresponding to the table.

As is apparent from FIG. 30, the posture parameters successively gently change.

The second embodiment, since the smoothing processing for the rotational angular velocity may be commonly applied the smoothing processing for the posture parameter, the processing routine is simple and contributes for minimizing the hardware scale.

### [Image Display Program]

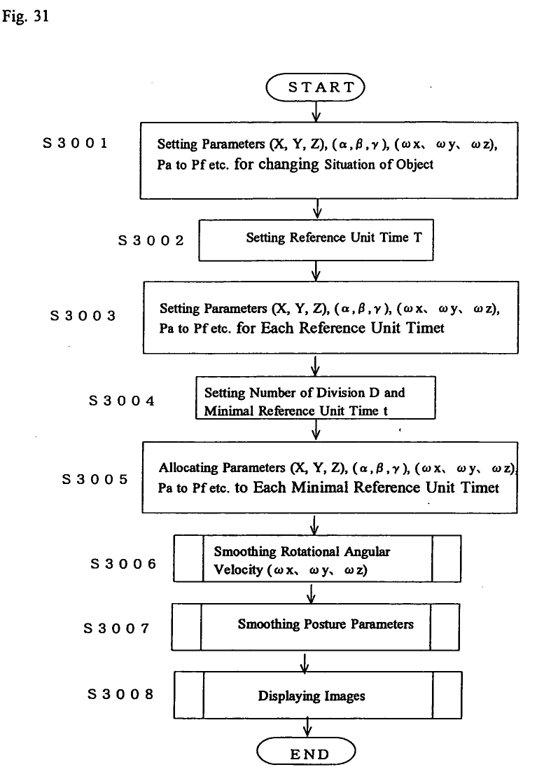

An image display program is shown in FIG. 31, for executing the above image display algorithm on the image display apparatus in FIG. 1.

The image display program of the second embodiment includes steps S3001 to S3006 and step 3008 similar to the steps S2701 to S2706 and step S2708 in the first embodiment. Only step S3007 in the second embodiment is different from the step S2707 in the first embodiment. The step S3707 executes the processing below.

That is,

Step S3007: Each of the posture parameters is smoothed independently from the others.

Therefore, each of the posture parameters changes moderately between 0% and 100% and natural change is realized.

The above embodiment is described concerning an image display processing for displaying the character diving, however, the present invention may be naturally applied to any image display of characters which rotates and changes in its posture in a virtual space, such as characters performing snowboarding, free-ski, mogul, water-skiing, trampoline, skateboard, skydiving, gymnastics etc.

### ADVANTAGES

According to the present invention, clear and natural movement is easily displayed. For example clear and natural rotational movement can be expressed even by a hardware of rather small size.

What is claimed is:

1. An image display program for displaying an image of a character in a virtual space, said program letting a computer execute steps of:
a parameter setting step for setting parameters concerning movement of said character;
a reference unit time setting step for setting a reference unit time of stepwise change of said parameters;
a minimal unit time setting step for setting a minimal unit time of a equally divided time of said reference unit time;
a parameter allocating step for allocating said parameters to each reference unit time, and for allocating said parameters to each said minimal unit time;
a smoothing step for setting a smoothed parameters for each said minimal unit time, said parameters being allocated to said minimal unit time; and
a display step for displaying said object according to said parameters set in said smoothing step for each minimal unit time.

2. An image display program according claim 1, wherein said smoothing step executes weighted addition of a plurality of said parameters of successive minimal unit times.

3. An image display program according claim 1, wherein said weighted addition of said smoothing step is executed by equal weights to one another.

4. An image display program according to claim 1, wherein said parameters includes a rotational angular velocity (ωx, ωy, ωz) around three dimensional coordinate axes (X-, Y- and Z-coordinate) in said virtual space, said rotational angular velocity ωx being rightward rotation around said X-axis viewing toward plus direction of said X-axis, said rotational angular velocity ωy being rightward rotation around said Y-axis viewing toward plus direction of said Y-axis, and said rotational angular velocity ωy being rightward rotation around said Z-axis viewing toward plus direction of said Z-axis.

5. An image display program according to claim 1, wherein said parameters includes a posture parameter indicative of posture of said character.

6. An image display program according to claim 1, wherein said reference unit time is approximately 0.5 sec.

7. An image display program according to claim 1, wherein said smoothing step sets a smoothed parameters of said successive minimal unit time.

8. An image display program according to claim 1, wherein said minimal unit time is a quarter of said reference unit time.

9. An image display apparatus for displaying an image of a character in a virtual space comprising:
a parameter setting means for setting parameters concerning movement of said character;
a reference unit time setting means for setting a reference unit time of stepwise change of the parameters;
a minimal unit time setting means for setting a minimal unit time of a equally divided time of said reference unit time;
a parameter allocating means for allocating said parameters to each reference unit time, and for allocating said parameters for each said minimal unit time:
a smoothing means for setting a smoothed parameters for each said minimal unit time, said parameters being allocated to said minimal unit time; and
a display means for displaying said object according to said parameters set by said smoothing means for each minimal unit time.

10. An image display apparatus according claim 9, wherein said smoothing means executes weighted addition of a plurality of said parameters of successive minimal unit times.

11. An image display apparatus according claim 10, wherein said weighted addition of said smoothing means is executed by equal weights to one another.

12. An image display apparatus according to claim 9, wherein said parameters includes a rotational angular velocity (ωx, ωy, ωz) around three dimensional coordinate axes (X-, Y- and Z-coordinate) in said virtual space, said rotational angular velocity ωx being rightward rotation around said X-axis viewing toward plus direction of said X-axis, said rotational angular velocity ωy being rightward rotation around said Y-axis viewing toward plus direction of said Y-axis, and said rotational angular velocity ωy being rightward rotation around said Z-axis viewing toward plus direction of said Z-axis.

13. An image display apparatus according to claim 9, wherein said parameters includes a posture parameter indicative of posture of said character.

14. An image display apparatus according to claim 9, wherein said reference unit time is approximately 0.5 sec.

15. An image display apparatus according to claim 9, wherein said smoothing means sets a smoothed parameters of said successive minimal unit time.

16. An image display apparatus according to claim 9, wherein said minimal unit time is a quarter of said reference unit time.

17. A memory medium in which program code for letting a computer execute each step of image display program according to claim 1.
